(19) United States
(12) Patent Application Publication
(10) Pub. No.: US 2025/0211593 A1
(43) Pub. Date: Jun. 26, 2025

(54) METHOD FOR INITIATING AN ADAPTATION OF AN ACCESS NETWORK

(71) Applicant: Robert Bosch GmbH, Stuttgart (DE)

(72) Inventors: David Osamu Ginthoer, stuttgart (DE); Davit Harutyunyan, Boeblingen (DE); Rene Guillaume, Boeblingen (DE)

(21) Appl. No.: 18/983,089

(22) Filed: Dec. 16, 2024

(30) Foreign Application Priority Data
Dec. 21, 2023 (DE) 10 2023 213 192.7

(51) Int. Cl. H04L 9/40; H04W 28/02

(52) U.S. Cl. CPC H04L 63/10; H04W 28/0268

(57) ABSTRACT

A method for initiating an adaptation of an access network. The method includes: determining an assignment between an application mode of an application and a service profile of an access network of a communications network based on received information relating to the access network and/or the application; retrieving a current network status of the access network and/or a current application mode; checking the current network status based on an assessment of whether the service profile of the access network satisfies a requirement for a current quality of service for the associated particular application mode and, based on the result of the check being positive, verifying the current application mode on the basis of an assessment of whether the application mode of the application has changed and, based on the result being positive, initiating an adaptation of the access network based on the current application mode and the determined assignment.

### FIELD

The present invention relates to a method for initiating an adaptation of an access network. The present invention also relates to a network function, a computer program and a computer-readable storage medium for this purpose.

### BACKGROUND INFORMATION

In a 5th-generation communications network according to the 3GPP standard or 5G communications network (5G), the quality-of-service (QOS) concept is applied for certain connections within the communications network. A connection in this context refers to a QoS flow within a PDU (protocol data unit) session. A PDU session is a logical connection within the 5G communications network that transmits IP packets or Ethernet frames between user equipment (UE) and a user plane function (UPF). In a 5G communications network, the so-called QOS flow represents the finest level of detail for differentiating the data traffic in terms of scheduling, queue management, rate control and more. The latter are characterized by a range of QOS attributes, which in turn are divided into QOS features and QOS parameters. Typical Qos parameters include, for example, a guaranteed data flow bit rate or a maximum data flow bit rate, along with parameters such as a packet loss rate or a packet delay budget. Furthermore, 5G in particular supports some limited adaptive QOS functions. For some Qos profiles with guaranteed bit rates, the 5G network can provide mechanisms for defining alternative QoS profiles in case the desired QoS profile cannot be supported by the network.

In its current form, 5G quality of service (QOS) is rather static and generally assigns only a single QoS profile to applications and user equipment (UE). However, practical applications can exhibit dynamic behavior that depends on the current operating state. In such cases, the QoS profile must meet the highest requirements of the application in order to ensure smooth operation. This often leads to network resources being overutilized. Although it is in principle possible to change the QoS profile of an active user or device in a 5G network, this is more likely to happen over longer periods of time and requires significant signaling effort to modify the end-to-end QoS flow. For reasons of service continuity, this may not be desirable. This is in particular true for applications that change their state in short intervals, e.g., a machine that waits in an idle state between executions of different tasks.

Furthermore, existing 5G Qos adaptation functions only take into account Qos changes on the basis of network conditions. For example, after switching to a new cell, a device receives a different QoS profile if it cannot be supported, and 5G triggers a corresponding notification both at the UE and via the network exposure function (NEF).

### SUMMARY

The present invention includes a method, a network function, a computer program, and a computer-readable storage medium. Features and details of the present invention are disclosed herein. Features and details described in connection with the method according to the present invention also apply in connection with the network function according to the present invention, the computer program according to the present invention, and the computer-readable storage medium according to the present invention, and respectively vice versa, so that, with respect to the disclosure, mutual reference is or can be made to the individual aspects of the present invention at all times.

The present invention relates in particular to a method for initiating an adaptation of an access network. According to an example embodiment of the present invention, the method comprises the following steps:
determining an assignment between an application mode of an application and a service profile of an access network of a communications network on the basis of received information relating to the access network and/or relating to the application,
retrieving a current network status of the access network and/or a current application mode,
checking the current network status on the basis of an assessment of whether the service profile of the access network satisfies a requirement for a current quality of service for the associated particular application mode and, if the result of the check is positive, the method proceeds to the next step,
verifying the current application mode on the basis of an assessment of whether the application mode of the application has changed and, if the result is positive, the method proceeds to the next step,
initiating an adaptation of the access network on the basis of the current application mode and on the basis of the determined assignment.

This has the advantage that overloading of network resources in an access network (RAN) of a communications network for an application can be significantly reduced because the adaptation is based on the actual current requirements, in order to better utilize the network resources. Furthermore, this makes it possible for an adaptation to be carried out much more quickly and more effectively, i.e., in near real time, because the present invention can respond more dynamically to changes in the access network or in the application mode on the basis of the determined assignment of the application mode of an application and the service profile of an access network of a communications network. Furthermore, this makes it possible to respond to overloading of network resources in the access network or a deterioration of the available communications service quality by transferring an application into another operating mode which requires fewer resources, in order to counteract an abrupt termination or a critical error of the application.

The service profile is preferably a QoS profile. The term “service profile” can be understood as a set of parameters, in particular parameter values, which represent or characterize the service or its properties, in particular the quality of service. A QOS profile can be represented, for example, by one or more parameters, in particular their values, which characterize the communications network or the network status, in particular of the access network. The parameters can be selected from latency, data rate, packet error rate, delay, etc. Service profiles can differ in the values of the parameters that represent or characterize the service or its properties.

According to an example embodiment of the present invention, it is also possible that the step of determining is preceded by at least one of the following steps:
receiving information relating to the application, the information comprising at least one application mode of the application, and/or
receiving information relating to the access network, the information comprising at least one parameter relating to the quality of service and/or the service profile of the access network.

This makes it possible for the broker or the broker function to assign the application mode and the service profile of the access network advantageously more quickly and more efficiently on the basis of the received information.

For example, the adaptation of the access network can be initiated via an exposure interface of the O-RAN system, in particular via an E2 interface.

This has the advantage that the resources in the access network (RAN) can be better utilized because an exposure interface makes it possible for use of RAN information in the RIC to be ensured and for the RAN behavior to be controlled and/or monitored by an RIC unit through policies via the E2 interface at the same time. Furthermore, this makes it possible to ensure a better quality of the services in the communications network. It also makes it possible to adapt to changes in the network demand and in the service profiles more quickly by advantageously being able to configure the RAN components more flexibly. An “exposure interface” in an access network or open radio access network (ORAN) can be understood as an interface that serves to make functions and services of an ORAN network available to external applications or service providers. In the context of OPEN RAN, the exposure interface makes it possible to expose information, control functions and data generated by ORAN network components such as base stations (radio access units, RAN) or network management systems. Furthermore, this interface advantageously makes it possible to program and optimize the RAN better via a non-real-time RIC (non-RT RIC) and a near-real-time RIC (near-RT RIC).

According to an example embodiment of the present invention, optionally, the access network can be adapted in real time. This makes it possible to adapt a network configuration of the access network promptly within the framework of quality of service, even in the case of time-critical network scenarios and/or time-critical applications.

According to a further advantage, in case of a negative result of the check, the method can comprise the following step:
sending a message relating to the negative result of the check to the application, the message containing information with respect to an insufficient quality of service for the associated particular application mode.

This has the advantage that the notified application can be informed quickly and flexibly so that the application itself can decide more quickly whether a (counter) measure should be initiated. If a (counter) measure is initiated, it can be provided that the application communicates any changed network requirements to the access network (via the broker) so that the available network resources can be adapted.

According to an example embodiment of the present invention, it is also optionally possible that, in case of a negative result of the verification, the method comprises the following step:
retrieving a further current network status of the access network in order to carry out a check again.

This makes it possible to use more current information relating to the access network to be able to check a requirement for adaptation action significantly more effectively.

A further advantage within the scope of the present invention can be achieved if initiating comprises the following further step:
sending a trigger in the form of a message relating to the adaptation of the access network to the application in order to communicate that the access network is being adapted on the basis of the determined assignment before the application is started.

This makes it possible for the broker to initiate the necessary measures more quickly, more efficiently and on a timely basis before an application is started. It is furthermore possible that the broker can know in advance when the application mode of the application changes. This knowledge can, for example, comprise learned information or external information in order to know, for example, a future state of a system or of a device and thus its application or operating mode. The broker can optionally prepare a (RAN) trigger in the form of a message to the application in advance.

It is also possible that a network function, in particular a broker function, is assigned to an xApplication and/or an rApplication.

This has the advantage that more efficient adaptation of the required quality of service can be ensured. Furthermore, this has the advantage that the network function, in particular the broker, can be designed as a standardized xApplication, which advantageously makes it possible optionally to install the network function on every O-RAN system. Alternatively, the method according to the present invention can be performed as an interoperable function on every O-RAN-compatible system as needed.

The present invention also relates to a network function for initiating an adaptation of an access network, in particular a broker function configured to perform the method according to one of the embodiments disclosed herein. The network function according to the present invention thus has the same advantages as have been described in detail with reference to the method according to the present invention.

The present invention also relates to a computer program comprising commands that, when the computer program is executed by a network function, cause the network function to perform the method according to the present invention. The computer program according to the present invention thus has the same advantages as have been described in detail with reference to a method according to the present invention.

The present invention also relates to a computer-readable storage medium comprising commands that, when executed by a network function, cause the network function to perform the steps of the method according to the present invention. The computer-readable storage medium according to the present invention thus has the same advantages as have been described in detail with reference to the method according to the present invention.

Furthermore, the method according to the present invention can also be carried out as a computer-implemented method.

Further advantages, features and details of the present invention can be found in the following description, in which exemplary embodiments of the present invention are described in detail with reference to the figures. The features mentioned or shown in the disclosure can be essential to the present invention, individually or in any combination.

### BRIEF DESCRIPTION OF THE DRAWINGS

FIG. 1 is a schematic visualization of a method, a network function, a storage medium and a computer program according to exemplary embodiments of the present invention.

FIG. 2 is a schematic representation according to exemplary embodiments of the present invention.

FIG. 3 is a schematic representation according to exemplary embodiments of the present invention.

### DETAILED DESCRIPTION OF EXAMPLE EMBODIMENTS

In the following figures, identical reference signs are also used for the same technical features of different embodiments.

The core of the present invention is a network function, in particular a broker function or broker, which can be arranged between the access network or radio access network (RAN) and the application. The RAN can provide the broker with its quality-of-service (QOS) capabilities, RAN mechanisms and RAN functions, scheduling parameters, current network states, and/or the state of certain network participants via a so-called exposure interface. Furthermore, the application can also transmit application-related information to the broker via the exposure interface. This application-related information can comprise the different operating modes of the application, criticality of the operating modes, current state of the operating modes, the ability to switch between certain operating modes, and/or the respective Qos requirements. If the application does not explicitly disclose its QOS requirements, this information can also be derived by the broker in another way: For example, this information could be obtained by observing RAN performance over time using machine learning mechanisms. In another example, this information could be explicitly configured in the broker by an engineer on the basis of application knowledge.

The core idea of the present invention is that the broker can determine an assignment between the application modes and the RAN configurations and can adapt the RAN on the basis of the current state of the application in near real time. To this end, the broker can use the O-RAN elements such as an RIC controller, for example the near-RT and/or non-RT RIC, to control the RAN. The broker can be provided or implemented as an xApplication, xApp or as an rApplication, rApp. The present invention takes into account a QoS adaptation that has been triggered by the external application and is based on the actual current requirements, in order to utilize the limited network resources better, and/or a RAN-limited adaptation within the existing Qos framework in order to make adaptation possible in near real time. Furthermore, the present invention takes into account a network-triggered quality-of-service (QOS) and application adaptation, which is unavoidable due to the current network quality or is initiated for optimization reasons.

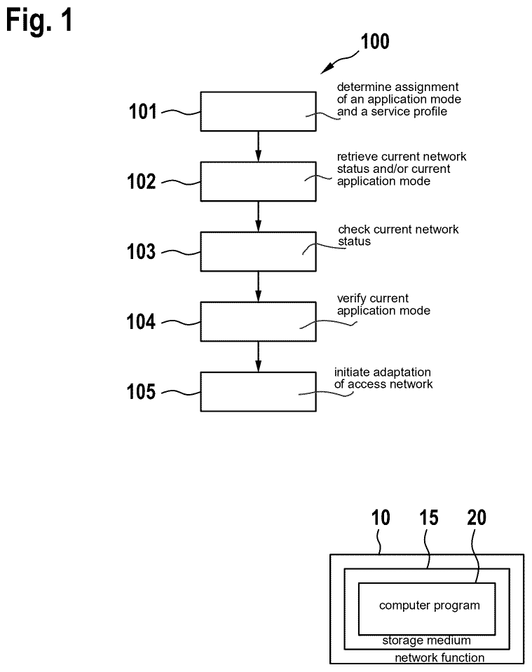

FIG. 1 schematically shows a method 100, a network function 10, a storage medium 15 and a computer program 20 according to exemplary embodiments of the present invention. FIG. 1 illustrates a method 100 for initiating an adaptation of an access network, according to exemplary embodiments of the present invention. The method 100 comprises the following steps:

In step 101, an assignment of an application mode of an application and a service profile of an access network of a communications network is determined on the basis of received information, for example quality parameters, relating to the access network and/or relating to the application. In step 102, a current network status of the access network and/or a current application mode is retrieved. In step 103, the current network status is checked on the basis of an assessment of whether the service profile of the access network RAN satisfies a requirement of the application for a current quality of service for the associated particular application mode. If the result of the check is positive, the method proceeds to the next step. In step 104, the current application mode is verified on the basis of an assessment of whether the application mode of the application has changed. If the result is positive, the method proceeds to the next step. In step 105, an adaptation of the access network is initiated on the basis of the current application mode and on the basis of the determined 101 assignment.

Optionally, it is possible that the adaptation of the access network is initiated 105 via an exposure interface of the O-RAN system, in particular via an E2 interface. Furthermore, it is optionally possible for the access network to be adapted in real time.

Furthermore, FIG. 1 shows a network function 10 or a broker 10, which comprises a computer-readable storage medium 15. The storage medium 15 comprises a computer program 20.

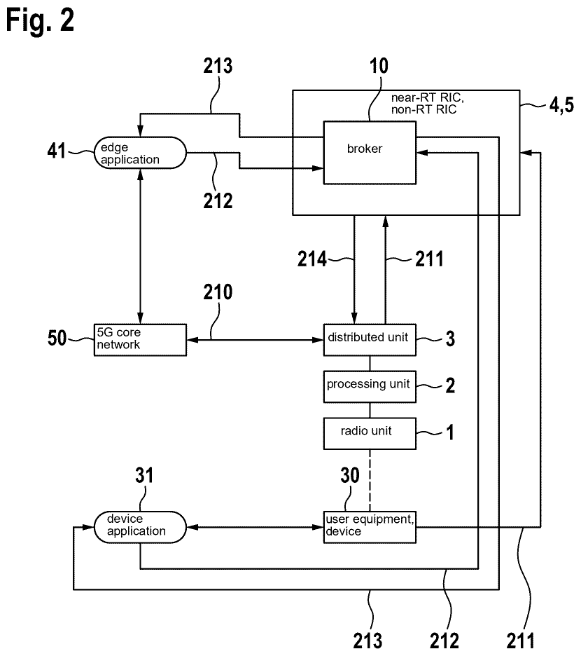

FIG. 2 is a schematic representation according to exemplary embodiments of the present invention. In particular, FIG. 2 shows a broker function 10 or a broker 10 in an O-RAN system. Furthermore, FIG. 2 shows a radio unit 1 (RU), a distributed unit 2 (DU) and a centralized unit 3 (CU) as components of an O-RAN system. The radio unit 1 (RU) is the hardware component responsible for signal transmission. It contains transmitter and receiver antennas along with the processing units for signal processing. The processing unit 2, or the distributed unit 2 (DU), is a component that is placed near the radio unit 1. This component 2 takes on signal processing tasks in order to minimize latency and optimize performance. The centralized unit 3 (CU) is an element of the OPEN RAN system and can perform various central control and management functions. The centralized unit 3 coordinates and controls all RU and DU units 1, 2 in the network and inter alia also communicates 210 for this purpose with the 5G core network 50, for example. Furthermore, FIG. 2 shows that information relating to policies and/or service profiles of the access network can be transmitted 214 between the centralized unit 3 and the broker 10. The centralized unit 3 (CU) and the processing unit 2 (DU) can be responsible for signal processing tasks within the OPEN RAN system.

In addition, FIG. 2 shows a RAN intelligent controller (RIC) for near-real-time applications 4 (near-RT RIC), which makes it possible to control and optimize O-RAN nodes or E2 nodes 1, 2, 3 (e.g., CU, DU, eNB, gNB) and resources in near real time. FIG. 2 also shows a non-real-time RAN intelligent controller 5 (non-RT RIC), which is tasked with supporting the intelligent RAN optimization by providing policy-based guidance, ML model management and enrichment information for the near-RT RIC function. The broker 10 can be designed as a so-called xApp or an rApp. The xApp and the rApp are applications that are hosted on the near-RT RIC 4 and non-RT RIC 5, respectively, and can provide value-added services there. xApp stands for xApplication and refers to applications that run in the Open RAN architecture in the near-RT RIC 4. These applications can perform various functions within the RAN operation, such as optimizing the network, controlling resources or improving user experience. rApp stands for rApplication and refers specifically to applications that run in the non-RT RIC 5 and perform less time-critical applications that interact with the management layer of the radio access network components in an Open RAN environment. Each RIC controller 4, 5 is to be understood as a core element of the O-RAN architecture, which makes it possible to program and optimize the RAN better via a non-real-time RIC (non-RT RIC) 5 and a near-RT RIC 4.

By way of example, FIG. 2 shows for an exemplary embodiment that the broker 10 can be designed as an xApp and/or rApp in the corresponding RIC controller 4, 5. The particular selection of xApp or rApp for the broker 10 may depend on the desired Qos update interval.

In a further exemplary embodiment (not shown), the broker 10 can be provided independently in an O-RAN system, for example as a network function 10, in particular as a management function 10.

Alternatively, the broker 10 can be formed as part of a third-party application, which can be located outside the network. For example, as part of an edge app 41 or a device application 31 on user equipment 30 or on a device 30. Depending on the aforementioned implementation variant of the broker 10, the application 41 would use corresponding interfaces to the near- and/or non-real-time RIC 4, 5 or to an xApp/rApp for controlling the RAN functions in order to exchange information on the network status 211 or the application status 212.

Furthermore, FIG. 2 shows by way of example how information can be communicated according to the method of the present invention between the components. Thus, FIG. 2 shows that the broker 10 can send 213 a notification to the applications 31, 41.

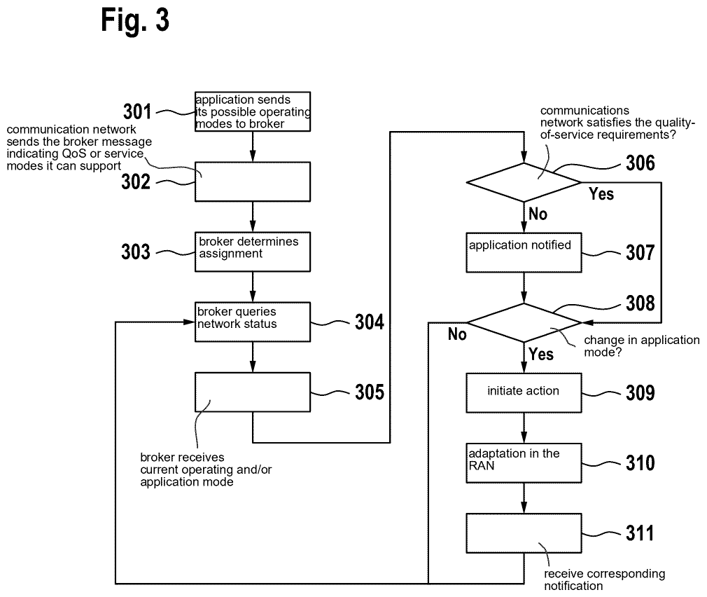

FIG. 3 is a schematic representation according to exemplary embodiments of the present invention. In particular, FIG. 3 shows by way of example a sequence diagram depicting a process flow for a broker 10 according to an exemplary embodiment of the present invention.

In an initialization phase, an application sends its possible operating modes to the broker 10 in step 301. The operating or application modes can comprise associated quality (QoS) parameters, such as a 5G Qos identifier, an allocation and storage priority, a reflective Qos attribute, a guaranteed flow bit rate, a maximum data flow bit rate, a maximum packet loss rate or a packet error rate. This information can be provided in the O-RAN context as part of external enrichment information.

In step 302, the communications network sends the broker 10 at least one message indicating which quality (QoS) or service modes the communications network can support. This at least one message can, for example, comprise information about the available bandwidth, available RAN functions, priority levels, or scheduling mechanisms.

On the basis of this information, the (Qos) broker 10 determines an assignment between each operating mode of the application and the corresponding RAN service profile in step 303. For example, this can be a service profile, a specific RAN function, a scheduling configuration or a reservation mechanism, which triggers a particular RAN behavior that meets the requirements of the application for each operating mode.

After the assignment, during an operating phase, the broker 10 can query the network status via an E2 interface in step 304 in order to determine whether the network can support the current service quality (Qos) and the associated application mode.

In step 305, the broker 10 retrieves the current operating and/or application mode of the application. For example, this information can be provided in the O-RAN context as part of external enrichment information.

In step 306, the broker 10 checks whether the communications network satisfies the quality-of-service requirements. If the communications network does not support the current quality requirements or a quality-of-service agreement, the application is notified accordingly in step 307. The broker 10 itself has no direct influence on the application. Only the application can take or not take necessary measures on the basis of the information received from the broker 10 according to step 307.

However, if the broker 10 detects a change in the application mode in step 308, the broker 10 initiates a corresponding action in step 309 on the basis of the assignment determined in step 303. The broker 10 can then initiate such an adaptation in the RAN via the E2 interface in step 310. The application would then receive a corresponding notification in step 311.

This notification can be used, for example, as a confirmation or as a trigger for starting the application, if it is crucial that the RAN is adapted accordingly before the application is to start operating. In another example, the broker 10 can know in advance when the operating mode of the application changes. This can either be learned information and/or external information, such as from a factory management system, which knows the future state of the systems and thus their operating mode. The broker 10 can prepare a corresponding configuration and communicate it to the RAN components via the corresponding interfaces. When a corresponding event occurs, the broker 10 can send a trigger so that the prepared configuration is executed with minimal delay.

The described process flow can be repeated as often as required depending on various triggers in the communications network or in the application.

An application can comprise various application or operating modes, each of which may have different traffic characteristics. For example, in an industrial environment, a so-called driverless transport system (DTS) can have different quality requirements depending on its current operating state. Different tasks, such as picking up goods, driving or parking, can have different traffic characteristics for the DTS, in particular if many control parts are outsourced to a cloud server. A further example is a video camera whose video images are only needed at certain times. Another example is a wirelessly controlled robotic arm that works only if it receives a new task. Otherwise, it remains in an idle state. In these examples, various parameters such as latency and bandwidth can vary greatly between different operating states.

For each time-critical service, a user or the 5G network can define a QoS profile based on standard quality parameters. The most important parameters for time-critical services include, for example, a guaranteed bit rate and a packet delay budget. However, the 3GPP technical specification does not regulate how this QOS could be enforced in the RAN. The forwarding mechanisms and the corresponding configurations are generally manufacturer-specific. Semi-persistent scheduling methods are often used in the RAN in order to guarantee timely delivery by blocking resources for a particular user. This has the disadvantage that the radio resources for a particular service can be blocked. Furthermore, it is possible in the RAN to program various Qos parameters, for example in the form of scheduling weights, relative prioritizations, or internal reservation mechanisms. An open RAN that provides RAN functions in order to change such parameters offers the possibility of adapting the RAN behavior beyond the coarse QOS classification of the 3GPP technical specification. The present invention takes advantage of this possibility by being able to analyze and adapt the RAN behavior on the basis of the operating modes of the application. For example, if the application is in a non-critical state that does not require any time-critical services, resources can be released for other applications. Furthermore, it is possible for each application to communicate its possible operating modes to the Qos broker before execution. On the basis of these operating modes, the broker determines appropriate RAN configurations or Qos profiles. While the QOS framework remains unchanged, RAN method configurations are applied in order to take into account the changing state of the application in order to release resources where possible, thus increasing network utilization. In terms of time, changing the entire QOS flow affecting the core and the transport in the network is also not feasible. Instead, only the RAN is influenced by the Qos broker. There are various ways in which the Qos broker can influence the scheduling decisions in the RAN. For example, the relative priority between streams can be adapted depending on the operating mode. At the cost of reduced peak performance, this makes temporarily better resource fairness among users possible if the criticality of the application in its current mode permits it. In another example, the QoS broker can trigger a RAN function that activates and deactivates the semi-persistent scheduling for a particular stream. This would negatively affect the scheduling delay of the data stream, but would prevent resources for the data stream from being held back if the current operating mode does not require hard deadlines or does not require as much bandwidth as originally reserved. For example, the Qos broker can trigger a RAN function that changes the guaranteed bandwidth or the maximum flow bit rate if the application temporarily does not need them. This makes it possible to reuse the resources for other (elastic and non-critical) services in the RAN without changing the entire QOS flow for a particular stream.

The above description of the embodiments describes the present invention exclusively in the context of examples. Of course, individual features of the embodiments, provided they make technical sense, can be freely combined with one another without departing from the scope of the present invention.

1-11. (canceled)

12. A method for initiating an adaptation of an access network, comprising the following steps:
determining an assignment between an application mode of an application and a service profile of an access network of a communications network based on received information relating to the access network and/or relating to the application;
retrieving a current network status of the access network and/or a current application mode;
checking the current network status based on an assessment of whether the service profile of the access network satisfies a requirement for a current quality of service for the application mode of the application;
based on a result of the check being positive, verifying the current application mode based on an assessment of whether the application mode of the application has changed; and
based on a result of the verifying being positive, initiating an adaptation of the access network based on the current application mode and based on the determined assignment.

13. The method according to claim 12, wherein the determining step is preceded by at least one of the following further steps:
receiving information relating to the application, the information including the application mode of the application, and/or
receiving information relating to the access network, the information including at least one parameter relating to the quality of service and/or the service profile of the access network.

14. The method according to claim 12, wherein the adaptation of the access network is initiated via an exposure interface of an O-RAN system, including via an E2 interface.

15. The method according to claim 14, wherein the adaptation of the access network is in real time.

16. The method according to claim claim 12, wherein, based on a negative result of the checking, the following step is performed:
sending a message relating to the negative result of the check to the application, the message containing information with respect to an insufficient quality of service for the application mode of the application.

17. The method according to claim 12, wherein, based on a negative result of the verification, the following step is performed:
retrieving a further current network status of the access network to carry out the checking again.

18. The method according to claim 12, wherein the initiating includes the following further step:
sending a trigger in a form of a message relating to the adaptation of the access network to the application to communicate that the access network is being adapted on based on the determined assignment before the application is started.

19. The method according to claim 12, wherein a broker function is assigned to an xApplication and/or an rApplication.

20. A network function for initiating an adaptation of an access network, the network function including a broker function configured to perform the following steps:
determining an assignment between an application mode of an application and a service profile of an access network of a communications network based on received information relating to the access network and/or relating to the application;
retrieving a current network status of the access network and/or a current application mode;
checking the current network status based on an assessment of whether the service profile of the access network satisfies a requirement for a current quality of service for the application mode of the application;
based on a result of the check being positive, verifying the current application mode based on an assessment of whether the application mode of the application has changed; and
based on a result of the verifying being positive, initiating an adaptation of the access network based on the current application mode and based on the determined assignment.

21. A non-transitory computer-readable storage medium on which are stored commands rising commands for initiating an adaptation of an access network, the commands, when executed by a network function, causing the network function to perform the following steps:
determining an assignment between an application mode of an application and a service profile of an access network of a communications network based on received information relating to the access network and/or relating to the application;
retrieving a current network status of the access network and/or a current application mode;
checking the current network status based on an assessment of whether the service profile of the access network satisfies a requirement for a current quality of service for the application mode of the application;
based on a result of the check being positive, verifying the current application mode based on an assessment of whether the application mode of the application has changed; and
based on a result of the verifying being positive, initiating an adaptation of the access network based on the current application mode and based on the determined assignment.
